(19) United States
(12) Patent Application Publication
(10) Pub. No.: US 2002/0158121 A1
(43) Pub. Date: Oct. 31, 2002

(54) Methods, apparatuses and computer program products for capturing and analysing attempts by a reader device to read data off a data-holding entity

(75) Inventor: Andrew James Stanford-Clark, Chale (GB)

Correspondence Address: IBM Corp, IP Law, 11400 Burnett Road, Zip 4054, Austin, TX, 78758, US

(73) Assignee: International Business Machines Corportion, Armonk, NY (US)

(21) Appl. No.: 09/935,399

(22) Filed: Aug. 23, 2001

(30) Foreign Application Priority Data
Apr. 27, 2001 (GB) 0110329.0

(51) Int. Cl. G06F 17/00

(52) U.S. Cl. 235/375

(57) ABSTRACT

The present invention relates to the monitoring of attempts by a reader device at reading data off a data-holding entity. Data relating to the attempt at reading the data-holding entity is received and responsive to the attempt not being successful, one is added to a read count which is used to determine the working order of the data-holding entity. The data obtained from a successful read, along transaction information is transmitted to a processing entity. This information is stored along with information relating to other data-holding entity transactions. The totality of information is periodically analysed in order to identify those data-holding entities which are repeatedly failing to be read within a predetermined number of reads/reader devices which are repeatedly failing to work properly. New data-holding entities/reader devices are sent out as appropriate.

### FIELD OF INVENTION

The present invention relates to capturing and analysing attempts by a reader device to read data off a data-holding entity. The term data-holding entity shall be taken to encompass all data carrying apparatus' that can be presented to a reader, as well as personal data that can be captured by a biometric reader.

### BACKGROUND OF THE INVENTION

Credit-cards are now commonplace. Consumers are carrying less and less cash, favouring instead to pay for their purchases by card. In 1999 alone US customers charged $1.2 trillion on their credit-cards.

FIG. 1 illustrates a typical credit card, with FIG. 1a showing the front-side, and FIG. 1b showing the underside.

Credit card 10a/b is a thin plastic card. The front-side 10a, consists of a creditor logo 20 (e.g. Diners Club International(i) and identification information including a card number 30 and a customer name 50. A valid from date 40 and expiry date 60 are also present.

The totality of information is used by the creditor to verify and keep a record of the purchases made on the card by a customer. Whilst department stores have their own numbering methods, most credit card companies adhere to the ANSI Numbering Standard X4.13-1983. Thus the first digit of the card number denotes the system. For example a 4 indicates Visa^{(R)} and a 5 indicates MasterCard^{(R)}. The remainder of the card number is dependent upon the type of card. For instance, with a Visa card digits 2 to 6 typically equate to a bank number, digits 7 to 12 or 7 to 15 denote an account number and digit 13 or 16 is a check digit.

The information printed/embossed on the front of credit card 10a is encoded within the magnetic stripe 70 on the underside of the credit card lob (see FIG. 1b). The magnetic stripe typically consists of three tracks which adhere to the ISO/IEC standard 7811. Credit card companies tend to use either track one or track two, since track three is not standardised amongst banks. The ISO/IEC standard does not permit alphanumeric data to be encoded in tracks 2 or 3, hence those companies who wish to include a customer name generally use track one which allocates 2 to 26 characters for this purpose. Note, an overview of the makeup of a credit card can be found at “www.howstuffworks.com”.

Whilst being an extremely convenient way to pay for goods, credit cards are susceptible to fraudulent transactions and thus the underside 10b also provides a space for the owner's signature 80. This can then be compared with a signature provided by a customer in a shop to verify that they are authorised to make a particular transaction.

In order to process a customer's purchase, their credit card details must first be obtained off the magnetic stripe on the card's underside. This is typically achieved by swiping the card through a card reader, but is frequently a troublesome process.

Credit cards, indeed any card employing a magnetic stripe (e.g. bank cards, store cards, security ID cards etc.), are prone to wear. The magnetic stripe may become dirty or scratched, or even be totally erased. The latter can occur when the card is placed too close to a magnetic source.

A dirty magnetic stripe typically results in a card reader needing several attempts (i.e. swipes) at reading the card. A damaged magnetic stripe will most probably require the card number on the front-side to be entered manually. Thus the process can be extremely time-consuming for all concerned. The customer may be in a hurry, or there may be a long queue of people building up. Thus a worn card is not only frustrating, but also very embarrassing.

A further source of frustration and embarrassment may lie in the card reader itself. A reader will typically process hundreds or even thousands of transactions a day. It is therefore not surprising that they too are prone to failure/wear and tear.

Ultimately the frustration and embarrassment associated with the processing of credit card transactions results in a bad perception of both the retail outlet and the credit card company.

Japanese patent application JP09097412, discloses an apparatus for reading a magnetic stripe card and comparing the signal read with a stored threshold value. In response to the signal being lower than the threshold, a warning signal is issued. However if a customer's credit card details fail to be read on a first swipe through a card reader, the customer is already aware that the signal read from the card is not good enough. A warning signal does nothing to improve customer satisfaction. Neither does The prior art address the problem of a worn reader device.

It will therefore be appreciated that any type of readable card can become worn. It will further be appreciated that other data-holding entities as defined above can also become worn as can any device capable of reading such an entity.

### DISCLOSURE OF THE INVENTION

Accordingly, the invention provides a method for monitoring attempts by a reader device at reading data off a data-holding entity, said method comprising the steps of: receiving data relating to an attempt at reading said data-holding entity; and responsive to said attempt not being successful, adding one to a read count.

Preferably an error code is received when a read attempt is not successful. Alternatively the data read is received and is validated. If the data is not valid, then it is assumed that the attempt at reading the data-holding entity was not successful.

According to a preferred embodiment, it is possible to enter data relating to the data-holding entity via a keypad (for example, when swiping that data-holding entity through the reader does not yield a successful result after a number of repeated attempts). When data has to be entered via the keypad, this is recorded.

Note, the data entered via the keypad typically comprises the number on the front of the data-holding entity only and is not as comprehensive as that obtained from reading the entity's magnetic stripe, chip or other data-holding component.

According to a preferred embodiment, valid data along with information regarding the obtaining of that data is transmitted to an entity for processing a transaction relating to the data-holding entity. Such a processing entity may be a merchant bank in a credit card system. The merchant bank may then do some processing itself and also pass the information on to, for example, a credit card issuing bank. Note, the term transaction should be taken to include any reason for which the data-holding entity is read. For example to make a purchase; or to gain entry to a locked area/building which is only accessible with an access card (badge).

In one embodiment, the transaction information includes the read count which is preferably used to determine at least one of the working order of the data-holding entity and the working order of the device used to read the data-holding entity and is only transmitted to the processing entity if it is greater than a predetermined threshold (e.g. 2). A flag indicating that data was entered via the keypad is also only transmitted to the processing entity when set. This is because otherwise it is assumed that the data-holding entity is in good working order.

Preferably the information regarding the obtaining of the data includes a unique reader device ID which is sent to the processing entity. This term should be seen as including either the reader device ID or the ID of the cash register used with the reader device in a payment system, or another ID which is uniquely resolvable back to the reader device. Thus, for example, if multiple reader devices are used with a particular cash register then the cash register's ID is not sufficient. This is also true if reader devices are moved between cash registers. It should also be noted that whilst an ID may be unique within a particular retail outlet or chain etc., it is unlikely to be unique across all outlets being served by the processing entity (e.g. the merchant bank). For this reason it is preferable to prepend a retail outlet ID to the reader device/cash register ID in order to create a unique string.

Further preferably the information relating to the obtaining of the data off the data-holding entity further includes a date and timestamp.

Note in one embodiment the read count is not sent to the processing entity. Only the reader device ID is transmitted, but not unless there appears to be a problem with the associated reader. In other words when the read count is greater than a predetermined threshold. Or alternatively, only a unique data-holding entity identifier is sent. Again it is assumed that this identifier has been sent because the read count is greater than a predetermined threshold. Of course, the information sent is by way of example only and indeed both identifiers may be sent.

The invention further provides a method (method 2) for analysing the number of attempts at reading data off each of a plurality of data-holding entities, comprising the steps of: receiving information relating to a plurality of data-holding entity transactions; storing said information; and analysing the stored transaction information in order to identify at least one of said data-holding entities which are repeatedly failing to be read within a predetermined number of attempts and reader devices which are repeatedly failing to read data-holding entities within a predetermined number of attempts.

Preferably the transaction information includes a read count indicating the number of attempts at reading each data-holding entity before the successful completion of a transaction.

Further preferably the transaction information includes an indication that said data had to be entered via a keypad associated with a reader device attempting to read data of the data-holding entity.

In one embodiment data relating to all transactions received is stored and information relating to interesting transactions is flagged (e.g. those with a high number of swipes (read count) for a particular data-holding entity). This enables such information to be efficiently accessed.

In a preferred embodiment, transaction information is only stored for a particular data-holding entity if the read count is greater than a pre-determined threshold. This means that the storage is not unnecessarily cluttered with entries relating to data-holding entities that were read within the first few attempts. Alternatively, such information may only be received when the read-count is sufficiently high.

According to a preferred embodiment, the transaction information includes the date of the transaction and a timestamp. The transaction information further preferably includes a data-holding entity identifier. This is used to reference failing data-holding entities. The date and time information is used co discount insignificant data-holding entity and reader device information (see below).

Preferably, once failing data-holding entities have been identified a first appropriate action is taken. Information is stored relating to the owner of each data-holding entity for which transaction information is kept and the first appropriate action includes sending out a replacement data-holding entity using the stored information regarding each failing data-holding entity's owner.

Such a proactive response results in a much better perception of the data-holding entity issuer by greatly increasing customer satisfaction. By detecting data-holding entity faults early, the data-holding entity owner (i.e. the customer) and for example cashiers no longer have to endure the frustration and embarrassment of a worn data-holding entity and long queues. Frustration often exhibited by the other customers waiting to be served is also avoided. The whole experience of using the data-holding entity (e.g. the buying experience) becomes altogether more pleasant.

As previously mentioned, the transaction information preferably includes a reader device identifier. When the stored transaction information is analysed in order to identify reader devices which are repeatedly failing to read data-holding entities within a predetermined number of attempts, responsive to identifying any failing reader devices a second appropriate action is taken.

Transaction information associated with each identified reader device is preferably analysed. According to a preferred embodiment, responsive to the reader device only appearing for transactions within at least one specific time-frame, each entry relating to the reader device is discounted as insignificant. This is because a particular cashier's swiping action may, for example, be at fault. In such a situation, the reader device is only likely to appear as part of the stored transaction information within certain or specific time frames.

According to a preferred embodiment, responsive to the reader device only appearing for transactions within at least one specific time-frame and said transactions having a low read count and said data being entered via a keypad associated with said reader device, each entry relating to the reader device is also discounted as insignificant. This is again likely to be because a particular cashier prefers to enter data-holding entity details manually. Thus it is possible to deduce that the information recorded regarding such a reader device over a specific time period (i.e. during a particular cashier's shift) is likely to be insignificant and should be disregarded

In both of the above described embodiments, it is preferably determined whether a transaction appears within at least one specific time-frame by using a timestamp associated with that transaction.

According to one embodiment, a timestamp is used to determine network performance (i.e. the time taken from the swiping of a data-holding entity to the authorisation of the request). In one embodiment, the data is analysed to determine repeated poor network performance and the network provider is informed such that appropriate action can be taken (e.g. a technician can be dispatched, the network upgraded etc.). In one embodiment, the number of abandoned transactions probably due to network performance) is stored local to the merchant and this information is automatically transmitted to an appropriate entity for further action such as that described immediately above. (Of course, this information could be stored elsewhere but this could also encounter network delays.) In one embodiment, after a predetermined number of abandonments, payments are accepted without an online referral for a transaction authorisation.

According to a preferred embodiment, the stored information is analysed and responsive to identifying any failing reader devices, a second appropriate action is taken. (Preferably disregarding those results likely to be insignificant). In one embodiment, the second action comprises sending out a replacement reader device. It will be appreciated that the invention is in no way limited to such a course of action, but could for example involve sending out a technician.

In one embodiment, the relevant time frames are analysed and correlated with cashier ids also included in the transaction information.

Thus the analysis can be used to inform the provider of the reader that their reader is faulty. This can, for example, be deduced when a reader device requires a high number of swipes per data-holding entity. This information can be used to ensure that a new reader device is automatically provided to, for example, the owning store. Such actions in response to monitoring of read attempts ensures a much better perception of the data-holding entity issuer; the reader device provider; and the reader device manufacturer. Regarding the former, customers are unlikely to realise that it is the reader device at fault and not their data-holding entity. Thus the problems of all round frustration and embarrassment described above are once again applicable. By issuing a new reader device before the problem exacerbates, such emotions can be avoided. Further the owning store is duly-impressed by the reader device provider's response. Moreover, the perception of the manufacturer is improved because serious problems with their reader devices are avoided.

The invention further provides a computer program comprising program code adapted to perform a method as described above when the program is run on a computer.

The invention further provides an apparatus for monitoring attempts by a reader device at reading data off a data-holding entity, comprising: means for receiving data relating to an attempt at reading said data-holding entity; and means, responsive to said attempt not being successful, for adding one to a read count.

The invention yet further provides an apparatus (apparatus 2) for analysing the number of attempts at reading data off each of a plurality of data-holding entities, comprising: means for receiving information relating to a plurality of data-holding entity transactions; means for storing said information; and means for analysing the stored transaction information in order to identify at least one of said data-holding entities which are repeatedly failing to be read within a predetermined number of attempts and reader devices which are repeatedly failing to read data-holding entities within a predetermined number of attempts.

The invention still further provides a credit card system comprising: a card-issuing bank; a merchant bank; and the apparatus (apparatus 2) described above.

According to one embodiment the merchant bank has storage associated therewith and transaction information is stored relating to each transaction effected by a reader device served by the merchant bank. The analysing of the transaction information associated with each identified reader device is at said merchant bank. This is particularly advantageous since the same merchant bank should receive all transactions effected by a particular reader device. The card-issuing bank on the other hand, will receive only a portion of a particular reader device's transactions. Further it is typically the merchant bank which provides the reader devices to the retail outlets it serves. It should be noted that in such a system, a cashier is unlikely to mention to their superior that there is a problem with their reader device and especially if they move around cash registers then any problems are likely to get forgotten. Such an analysis is therefore extremely useful.

In one embodiment the only transaction information stored at the merchant is the reader device ID. It being assumed that any appearance of a particular reader device signifies a possible problem with it. However it is useful for the merchant bank to be able to compare notes with the card-issuing bank in order for their results to be more accurate (e.g. it could be the data-holding entities that are causing problems rather than the reader itself.)

Further, the unique reader device ID could be omitted from the information stored at the card-issuing bank. However it is useful to record in case a particular reader device or batch of reader devices are providing insignificant results and it is not a data-holding entity's (ies') fault. Of course the information stored at the merchant bank and/or card-issuing bank is not limited to that described above and is by way of example only.

It will therefore be appreciated that the transaction information or subset of that information may be stored at a number of different places within the credit card system (e.g. at the merchant bank; at the card-issuing bank etc.)

It should further be appreciated that the invention is preferably applicable to any data-holding entity employing a magnetic stripe (e.g. a security ID pass badge; a loyalty card; a store card; a credit card; a membership card etc.) It is also applicable to any other data-holding entity suitable for being read by a reader device (e.g. a key fob/transponder; smart card etc.) and is taken as encompassing data carrying apparatus' that can be presented to a reader, as well as personal data that can be captured by a biometric reader (e.g. an iris/fingerprint reader). Likewise, a data-holding entity transaction refers to any reason for which the data-holding entity is read. For example to make a purchase; or to gain entry to a badge locked area/building.

In one embodiment, the reader device is in an automatic teller machine (ATM) and the data-holding entity is a bank card. In another embodiment, the reader device is at least one of a fingerprint identification reader; and an iris identification reader.

### BRIEF DESCRIPTION OF THE DRAWINGS

A preferred embodiment of the present invention will now be described, by way of example only, and with reference to the following drawings:

FIGS. 1a and 1b show a typical credit card;

FIGS. 2a and 2b show how the details are obtained off a credit card at a point-of-sale unit in accordance with one embodiment of the present invention;

FIGS. 3a and 3b show the processing of a credit card transaction in accordance with one embodiment of the present invention;

FIG. 4 illustrates the entities involved in the processing of a credit card transaction in accordance with one embodiment of the present invention;

FIG. 5 illustrates the way in which the card issuing bank stores credit card information in accordance with one embodiment of the present invention; and

FIG. 6, the components which are present at the card issuing bank for enabling the analysis and subsequent processing of data received thereat in accordance with one embodiment of the present invention.

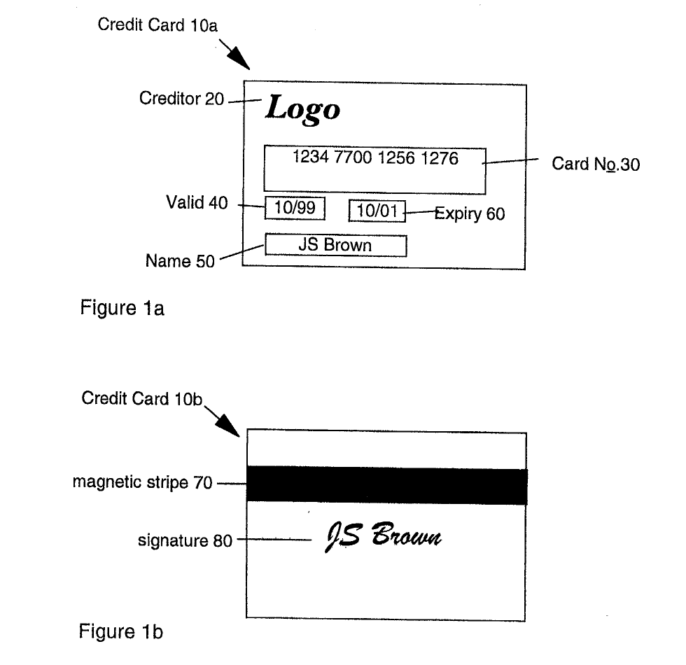

### DESCRIPTION OF THE PREFERRED EMBODIMENTS

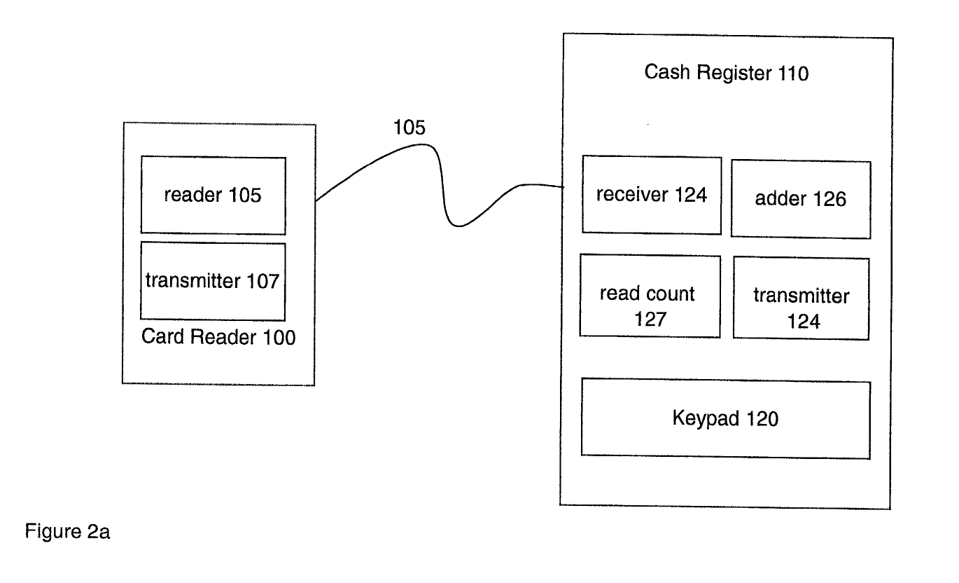

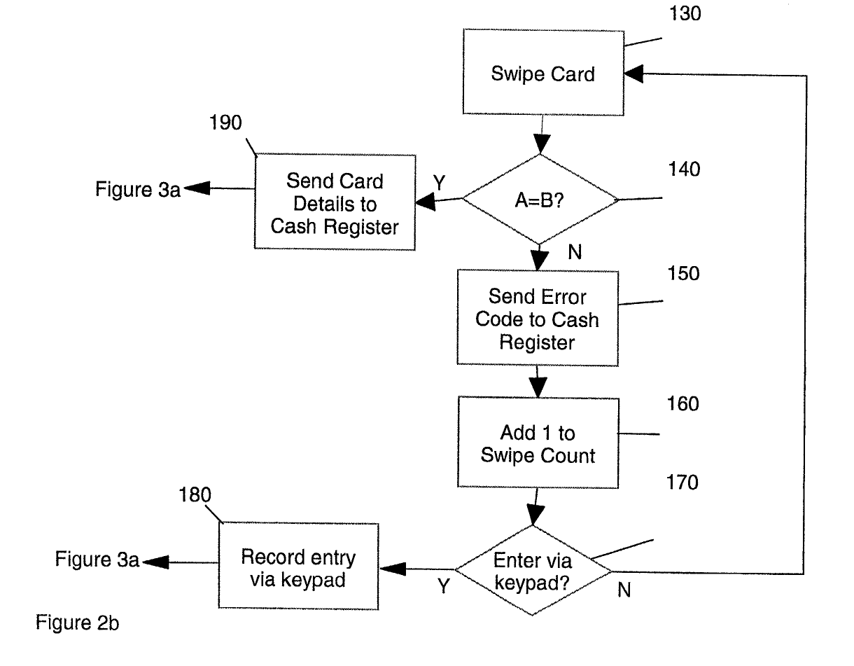

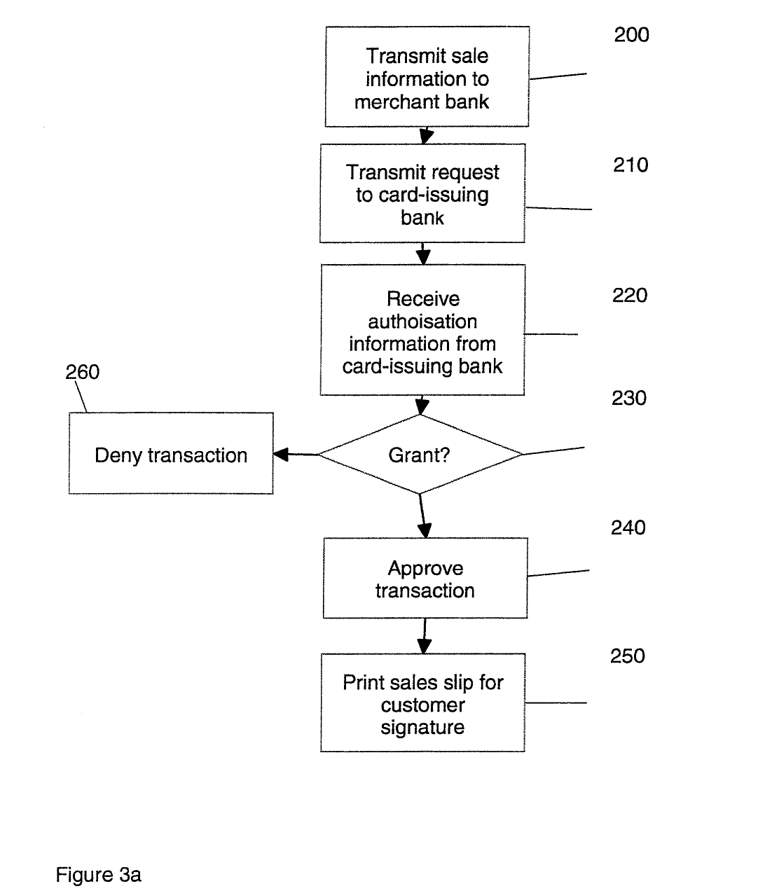

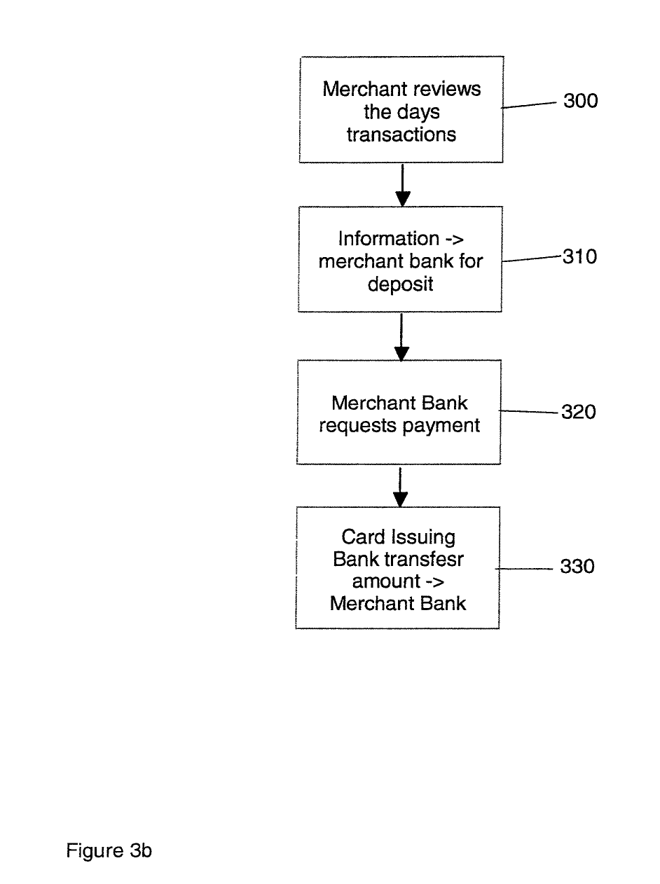

With reference to FIGS. 2a and 2b, a credit card (not shown) is swiped through card reader 100 (step 130). When the information shown on the front of the card was written to the card's magnetic stripe, a checksum digit (A) was calculated using this information. The card reader's reader component 105 calculates its own checksum (B) on the data it has read (using the same method), and if A equals B (step 140) then the card information has been correctly read. In this instance the information is sent over a link 105 to cash register 110 (step 190) by a transmitter component 107 and received by receiver component 124. Note the link may, for example, be a serial RS232 serial connection. The processing thenceforth is discussed with reference to FIGS. 3a, 3b and FIGS. 4 and 5.

If A does not equal B at step 140, then an error code is transmitted to cash register 110 (step 150) and this is received by receiver component 124. The cash register keeps a count of the number of swipes required to read each credit card's details (not shown). Receipt of this error code causes an adder 126 to add one to the swipe or read count 127 (step 160). The cashier can either swipe the card again, or enter the details via keypad 120 (step 170). If the details are entered by the keypad, then this is recorded at step 180. Further processing is discussed with reference to FIGS. 3a, 3b and FIGS. 4 and 5. The cashier may alternatively choose to swipe the card through the card reader again (step 130).

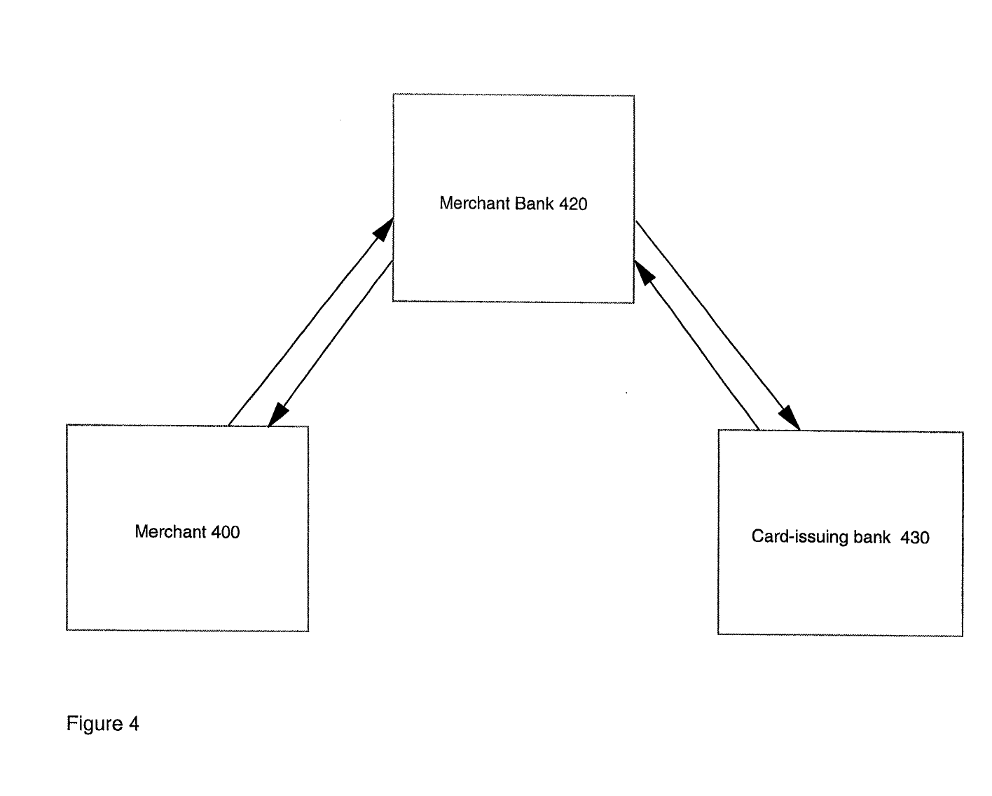

FIGS. 3a and 3b are flowcharts showing the way in which a credit card transaction is processed according to one embodiment of the present invention. These two figures should be read in conjunction with FIG. 4 which illustrates the entities typically involved in processing the credit card transaction.

Once the merchant 400 has obtained the credit card details and this information has been transmitted to the cash register, these details, along with a transaction date & time; an amount; the number of card swipes; whether the information-had to be entered via the keypad; and an authorisation request are transmitted using transmitter 124 (FIG. 2a) to the merchant's bank 420 (step 200). Note, the information sent to the merchant bank is by way of example only. For instance, the number of swipes does not always have to be sent to the merchant bank. In one embodiment, if the details are correctly read first time off a credit card (or within the first few attempts) then this information is not sent because it is assumed that the card is in good working order. Further, the information regarding the working order of the card (e.g. number of swipes) is, in one embodiment, not sent until authorisation for the transaction is received.

A card reader or cash register ID or other ID is also preferably transmitted to the merchant's bank. The ID is preferably a consistent one and should be uniquely resolvable back to the card reader. Thus, for example, if multiple card readers are used with a particular cash register then the cash register's ID alone is not sufficient. This is also true if card readers are moved between cash registers. It should also be noted that whilst an ID may be unique within a particular retail outlet or chain, it is unlikely to be unique across all outlets being served by the merchant bank. For this reason it is preferable to prepend a retail outlet ID to the card reader/cash register ID in order to create a unique string.

A request including all this information is then transmitted to the card-issuing bank 430 (step 210). The card-issuing bank verifies, for example, that the card has not been barred and that the owner of the card has enough available credit in their account (not shown) etc. Authorisation information is subsequently transmitted from the card-issuing bank and received by the merchant bank (step 220) and the outcome of the request is then sent to the merchant (step 230). Assuming that the card-issuing bank decided to allow the transaction, it is approved (step 240) and a sales slip is printed for the customer's signature (step 250). (Note, in this embodiment the card-issuing bank has flagged the customer's account for the transaction amount, but has not yet charged the customer). The customer's end of the process is now complete. If on the other hand, the transaction was not allowed by the card-issuing bank, then the merchant informs the customer of the denial (step 260) and the purchase must be returned to the shelf or paid for by another means.

FIG. 3b shows the process by which the merchant bank is paid for the transaction according to an embodiment of the present invention. Sometime later (e.g. at the end of the day when the shop is closed for business), the merchant reviews the transactions for which the merchant bank has not yet been paid (step 300). Sales slips are matched against authorisations stored in cash register and information regarding each verified transaction is sent to the merchant bank for the money owing to be deposited (step 310). Payment is subsequently requested by the merchant bank from the card-issuing bank at step 330 and the amount is transferred to the merchant bank (step 330). At this point the amount is charged to the customer's credit card. (The request includes the original authorisation code for verification purposes.) The whole process is now complete.

Information regarding an overview of credit card transaction processing according to the prior art can be found at:

“cs1.cs.nyu.edu/ms_students/rodr7076/e-commerce/midterm/M oreCreditCardBackground.htm”

Note, not all point of sale units transmit the sale information directly to the merchant bank and receive authorisation from the card-issuing bank whilst the customer is actually making a purchase. Thus the invention is just as applicable to systems where the information is transmitted at a later time (perhaps outside of business hours). Further other entities may be involved in the processing a credit card transaction than those depicted in FIG. 4. For example, information regarding a credit card transaction may be forwarded from the merchant's bank to the card-issuing bank, via a card association.

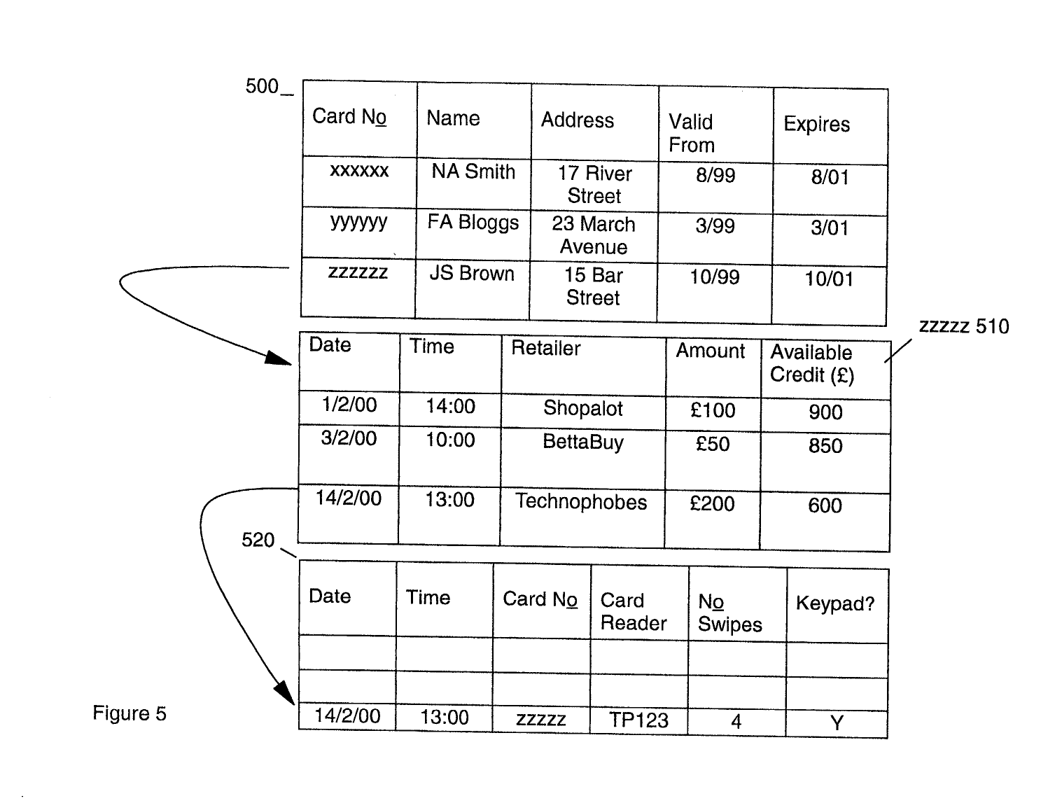

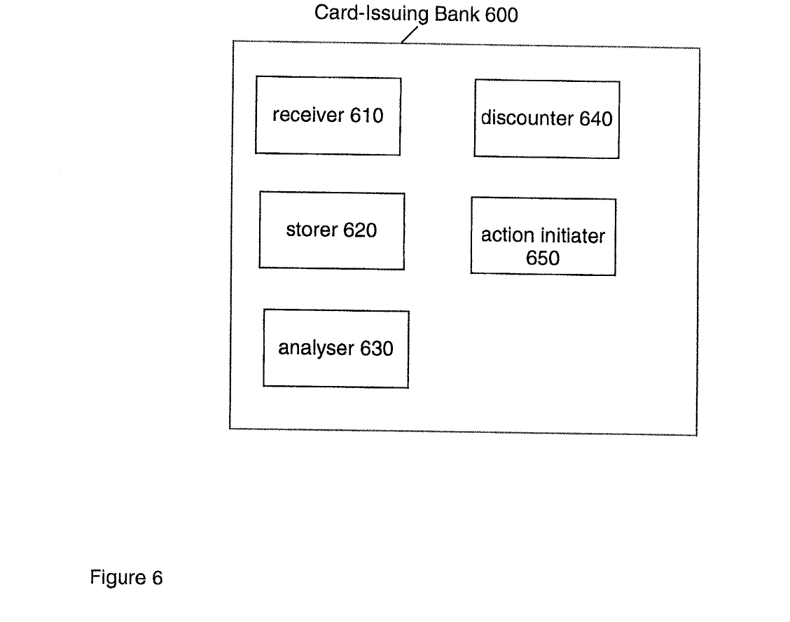

FIG. 5 illustrates the way in which the card issuing bank stores credit card information in accordance with one embodiment of the present invention. It should be read in conjunction with FIG. 6 which shows, the components which are present at the card issuing bank for enabling the analysis and subsequent processing of data received thereat in accordance with one embodiment of the present invention.

The information is received via receiver component 610 at the card issuing bank and is recorded or stored on non-volatile storage using storer 620 and via a plurality of tables 500, 510, 520, constructed using a relational database such as IBM's DB/2^{(R)} product. Note, this is by way of example only and the invention is in no way limited to such a setup.

Table 500 stores details of all cards registered with the card-issuing bank. These include, by way of example, a card number, an owner's name, their address, the date from which the card is valid and the date on which it expires. Note the card number is typically numeric, but depicted in the figure as alphabetic characters for ease only.

Each card number is used to key into another table listing the transactions charged to each card. In this example, table 510 shows a list of the transactions made by J S Brown's card, card number zzzzz. By way of example only, the table stores the date and time of each transaction; the retailer involved; the amount spent; and the available credit that a particular customer has. When authorisation for a particular transaction is requested, the available credit field may be one of those used to decide whether or not to permit the sale to go ahead. In this example, the sale is permitted and a transaction made on Feb. 14, 2000 is recorded.

The date; time; card number; card reader/cash register ID; number of swipes; and whether the card details had to be entered via the keypad are then recorded in table 520. Analyser 630 (i.e. data mining software) is used periodically (e.g. once a month) to statistically analyse the information stored in this table and gathered over a certain time frame (e.g. over the preceding month). For example, this could be achieved via a Standard Query Language (SQL) query on the relational database

If such a query determines that a particular card repeatedly requires greater than a predetermined number of swipes (e.g. 2); and/or the card's details are continually having to be entered via a cash register's keypad. Then the card-issuing bank can deduce that that card is likely to be faulty (i.e. . . . the magnetic stripe is damaged or has been erased). The information in table 520 can therefore be used to automatically issue the damaged card's owner with a replacement via action initiator 650. Note, the details stored in table 500 are used to determine where to send the replacement card. Further, according to one embodiment information is only stored in table 520 if the number of swipes exceeds a predetermined number; or if the card details have to be entered via the keypad. This means that the table is not unnecessarily cluttered with entries relating to cards that were read on a first attempt. Alternatively, as mentioned above the card-issuing bank is never informed when the card was read at the first/first few attempts and hence has no information to store in table 520.

Such a proactive response by the card-issuing bank results in a much better perception of the card issuer by greatly increasing customer satisfaction. By detecting card faults early, the customer and cashiers no longer have to endure the frustration and embarrassment of a worn card and long queues. Frustration often exhibited by the other customers waiting to be served is also be avoided. The buying experience becomes altogether more pleasant.

The information stored within table 520 can also be used to deduce whether a particular card reader is at fault. A profile of each card reader listed in table 520 within a certain time frame is built up. This profile includes the number of times a particular card reader had to swipe a card more than a predetermined number of times and the number of times a cashier had to enter the card details via the keypad during, for example, the day or month. It is useful for the query to correlate the swipe information with the keypad; date; and time information. This is because a particular cashier may, for example, prefer to enter card details manually. A particular cashier's swiping action may also be at fault.

Thus with the first example, if over a certain time period only the swipe count for a particular reader is continually low, and the details are always entered via the keypad, then it is possible to deduce that the information recorded in the table over this time period (i.e. . . . during a particular cashier's shift) is likely to be insignificant and should be disregarded. Discounter 640 interacts or forms part of analyser 630 and is used to make such a determination.

Further, if the swipe count is high and the keypad is continually used only within a specific time period, then it is once again possible to deduce that these results are likely to be insignificant. Of course a combination of these two examples could be the problem, and once again the results recorded over a specific time period are likely to be insignificant.

In the embodiment in which all card transactions are recorded in table 520, interesting row entries could be flagged at the time of storing the information (e.g. those with a high number of swipes for a particular card). This would enable the data mining software to access these rows efficiently without having to scour the whole table.

Disregarding the insignificant results using discounter 640, the card reader profile is used to inform the provider of the reader that their reader is faulty. This can, for example, be deduced when a card reader requires a high number of swipes per card. This information can be used to ensure that a new card reader is automatically provided to the owning store. This ensures a much better perception of the card-issuer; the card reader provider; and the card reader manufacturer. Regarding the former, customers are unlikely to realise that it is the card reader at fault and not their card. Thus the problems of all round frustration and embarrassment described above once again applicable. By issuing a new reader before the problem exacerbates, such emotions can be avoided. Further the retail outlet is duly impressed by the card reader provider's response. Moreover, the perception of the manufacturer is improved because serious problems with their readers are avoided. Note, a cashier is unlikely to mention to their superior that there is a problem with their card reader and especially if they move around cash registers then any problems are likely to get forgotten. Such an analysis is therefore extremely useful.

Note, in one embodiment data mining with regard to a card reader's performance is done at the merchant bank. In which case the merchant bank preferably stores in non-volatile storage a cut-down version of the information stored at the card-issuing bank. Each merchant served by the merchant bank has an account therewith and the details held can include, for example, a name; address and account number for each merchant. The merchant bank also keeps a record of each transaction communicated to it by a merchant, including the information contained within table 520 of FIG. 5.

Using data mining software to identify a faulty card reader at the merchant bank is particularly advantageous since the same merchant bank should receive all transactions effected by a particular card reader. The card-issuing bank on the other hand, will receive only a portion of a particular card reader's transactions. Further, it is typically the merchant bank which provides the card readers to the retail outlets it serves. In such a situation, card information could be omitted from the table. It being assumed that if a card reader appeared in the table then their was a possible problem with it. However it is useful for the merchant bank to be able to compare notes with the card-issuing bank in order for their results to be more accurate. Alternatively the card number could be omitted but the other card information included (e.g. number of swipes and whether the information had to be entered via the keypad.)

Further, the card reader information could be omitted from the information stored at the card-issuing bank. However it is useful to record in case a particular card reader or batch of card readers are providing insignificant results and it is not a card(s) fault. Of course the information stored at the merchant bank and/or card-issuing hank is not limited to that described above and is by way of example only. In one embodiment the number of swipes is not held. An entry regarding a particular card is only made if the number of swipes exceed a particular threshold, hence the fact that the card appears at all is sufficient to assume that there could be a problem. Note, it will be appreciated that the components listed in FIG. 6 (or a subset thereof) may also be present at the merchant bank. Alternatively components present at the card-issuing bank could be invoked by the merchant bank or vice-a-versa. It should be further noted that the information stored (FIG. 5) is not limited-to one or other of the merchant bank and card-issuing bank and is by way of example only.

It should be appreciated that the present invention is not just applicable to the processing of credit card transactions. It is also relevant to any type of card employing a magnetic stripe (e.g. security pass badges, store cards; loyalty cards, membership cards etc.); smart cards. Indeed it is also applicable to all data carrying (holding) apparatus, (entities) that can be presented to a reader, as well as personal data that can be captured by a biometric reader. Such apparatus' include, for example, key fobs for gaining entry to a building, making a payment etc.; finger print/iris identification for access purposes etc. With the latter, the invention is only applicable in so far as the identification of a faulty reader.

In one embodiment the number of swipes of a security pass badge through a badge reader is recorded. When the badge is finally read correctly, the number of swipes is associated with the owner details read off the card. Data mining software can once again be used to statistically analyse the number of swipes typically required by a badge over a certain time frame before the owner is allowed access to a door/a building(s). Such analysis is used to issue the owner with a replacement badge when it is determined to be failing. Data mining software can also, once again, be used to identify a failing badge reader. Each badge reader is allocated a unique ID and this is used to identify a reader causing an unusually high number of people access difficulty.

With a smartcard, the number of times that the card needs to be inserted into a smartcard reader can be recorded. As with the security pass badge, as soon as the details can be correctly read these are used to associate the number of inserts with an owner ID/details and with a particular reader via a unique reader ID.

Key fobs/transponders are also used to gain entry/make a payment etc. Mobil have developed the SpeedPass^{(R)}. A user pre-registers their credit card/account details with the Speedpass system. The registrant is allocated a key fob which when placed on/in front of a reader at, for example, the petrol station or in a retail outlet and is used to directly charge their purchase to their pre-registered payment means. This system provides a quick an easy way to pay. It will be appreciated that the present invention is also applicable to such a system or indeed any system employing key fobs or other devices prone to wear which hold owner information for use by a reading device (also prone to wear). More information on Speedpass can be obtained from “www.speedpass.com”.

Another example of the technology to which the present invention is also applicable is the Automatic Teller Machines (ATMs). The invention can be used to identify a failing bank card or failing machine.

What is claimed is:

1. A method for monitoring attempts by a reader device at reading data off a data-holding entity, said method comprising the steps of:
receiving data relating to an attempt at reading said data-holding entity; and
responsive to said attempt not being successful, adding one to a read count.

2. The method of claim 1, comprising the step of:
responsive to said received data being an error code, determining that said attempt was not successful.

3. The method of claim 1, wherein the received data is the data read of said data-holding entity, the method comprising the steps of:
determining whether said received data is valid; and
responsive to the received data not being valid, determining that said attempt was not successful.

4. The method of claim 1, comprising the steps of:
providing the option to receive data relating to said data-holding entity via a keypad; and
recording when said data is entered via said keypad.

5. The method of claim 1, comprising the step of:
transmitting valid data including the data read off the data-holding entity and information regarding the obtaining of that data to an entity for processing a transaction relating to said data-holding entity.

6. The method of claim x, wherein the information regarding the obtaining of the data includes the read count, said read count being used to determine at least one of the working order of the data-holding entity and the working order of the device used to read the data-holding entity, said read count only being transmitted to said processing entity if said count is greater than a predetermined threshold.

7. The method of claim 5, wherein the information regarding the obtaining of the data includes a flag indicating that data was entered via the keypad, said flag only being transmitted to the processing entity when set.

8. The method of claim 5, wherein the information regarding the obtaining of the data includes at least one of a unique reader device ID and a unique data-holding entity identifier.

9. The method of claim 8, wherein said unique reader device ID is only sent to the processing entity when the read count is greater than a predetermined threshold.

10. The method of claim 5, wherein the information regarding the obtaining of the data includes a date and time stamp.

11. A method for analysing the number of attempts at reading data off each of a plurality of data-holding entities, comprising the steps of:
receiving information relating to a plurality of data-holding entity transactions;
storing said information; and
analysing the stored transaction information in order to identify at least one of cards which are repeatedly failing to be read within a predetermined number of attempts and reader devices which are repeatedly failing to read data-holding entities within a predetermined number of attempts.

12. The method of claim 11, wherein said transaction information includes a read count indicating the number of attempts at reading each data-holding entity before the successful completion of a transaction.

13. The method of claim 11, wherein said transaction information includes an indication that said data had to be entered via a keypad associated with a reader device attempting to read data of said data-holding entity.

14. The method of claim 11, wherein information relating to interesting transactions is flagged.

15. The method of claim 11, wherein said transaction information is only stored for a particular data-holding entity if a read count is greater than a pre-determined threshold.

16. The method of claim 11, wherein the transaction information includes a date and timestamp.

17. The method of claim 16, wherein said transaction information includes a data-holding entity identifier.

18. The method of claim 16, further comprising the step of:
responsive to identifying the failing data-holding entities, taking a first appropriate action.

19. The method of claim 18, comprising the step of:
storing information relating to the owner of each data-holding entity for which transaction information is kept; and wherein said step of taking a first appropriate action further comprises:
using said stored information regarding each failing data-holding entity's owner to send out a replacement data-holding entity.

20. The method of claim 11, wherein the transaction information includes a reader device identifier.

21. The method of claim 20, wherein the step of analysing the stored transaction information comprises:
responsive to said reader device only appearing for transactions within at least one specific time-frame, discounting each entry relating to said reader device as insignificant, whether a transaction appears within said at least one specific time-frame being determined using a timestamp associated with said transaction.

22. The method of claim 20, wherein the step of analysing the stored transaction information comprises:
responsive to said reader device only appearing for transactions within at least one specific time-frame and said transactions having a low read count and said data being entered via a keypad associated with said reader device, discounting each entry relating to said reader device as insignificant, whether a transaction appears within said at least one specific time-frame being determined using a timestamp associated with said transaction.

23. The method of claim 11, comprising the step of:
responsive to identifying any failing reader devices, taking a second appropriate action.

24. The method of claim 23, wherein said step of taking a second appropriate action comprises sending out a replacement reader device.

25. The method of claim 1, wherein said data-holding entity is one of a security ID pass badge; a loyalty card; a store card; a membership card; a smart card; a key transponder; a bank card.

26. The method of claim 1, wherein said reader device is in an automatic teller machine and said data-holding entity is a bank card.

27. The method of claim 1, wherein said reader device is at least one of a fingerprint identification reader; and an iris identification reader.

28. An apparatus for monitoring attempts by a reader device at reading data off a data-holding entity, comprising:
means for receiving data relating to an attempt at reading said data-holding entity; and
means, responsive to said attempt not being successful, for adding one to a read count.

29. The apparatus of claim 28, comprising:
means, responsive to said received data being an error code, for determining that said attempt was not successful.

30. The apparatus of claim 28, wherein the received data is the data read of said data-holding entity, the apparatus comprising:
means for determining whether said received data is valid; and
means, responsive to the received data not being valid, for determining that said attempt was not successful.

31. The apparatus of claim 28, comprising:
means for receiving data relating to said data-holding entity via a keypad; and
means for recording when said data is entered via said keypad.

32. The apparatus of claim 28, comprising:
means for transmitting valid data including the data read off the data-holding entity and information regarding the obtaining of that data to an entity for processing a transaction relating to said data-holding entity.

33. The apparatus of claim 32, wherein the information regarding the obtaining of the data includes the read count, said read count being used to determine at least one of the working order of the data-holding entity and the working order of the device used to read the data-holding entity, said read count only being transmitted to said processing entity if said count is greater than a predetermined threshold.

34. The apparatus of claim 32, wherein the information regarding the obtaining of the data includes a flag indicating that data was entered via the keypad, said flag only being transmitted to the processing entity when set.

35. The apparatus of claim 32, the information regarding the obtaining of the data includes at least one of a unique reader device ID and a unique data-holding entity identifier.

36. The apparatus of claim 35, wherein said unique reader device ID is only sent to the processing entity when the read count is greater than a predetermined threshold.

37. The apparatus of claim 32, wherein the information regarding the obtaining of the data includes a date and time stamp.

38. An apparatus for analysing the number of attempts at reading data off each of a plurality of data-holding entities, comprising:
means for receiving information relating to a plurality of data-holding entity transactions;
means for storing said information; and
means for analysing the stored transaction information in order to identify at least one of data-holding entities which are repeatedly failing to be read within a predetermined number of attempts and reader devices which are repeatedly failing to read data-holding entities within a predetermined number of attempts.

39. The apparatus of claim 38, wherein said transaction information includes a read count indicating the number of attempts at reading each data-holding entity before the successful completion of a transaction.

40. The apparatus of claim 38, wherein said transaction information includes an indication that said data had to be entered via a keypad associated with a reader device attempting to read data of said data-holding entity.

41. The apparatus of claim 38, wherein information relating to interesting transactions is flagged.

42. The apparatus of claim 38, wherein said transaction information is only stored for a particular data-holding entity if a read count is greater than a pre-determined threshold.

43. The apparatus of claim 38, wherein the transaction information includes a date and timestamp.

44. The apparatus of claim 43, wherein said transaction information includes a data-holding entity identifier.

45. The apparatus of claim 43, further comprising:
means, responsive to identifying the failing data-holding entities, for taking a first appropriate action.

46. The apparatus of claim 45, comprising:
means for storing information relating to the owner of each data-holding entity for which transaction information is kept; and wherein the means for taking a first appropriate action further comprises:
means for using said stored information regarding each failing data-holding entity's owner to send out a replacement data-holding entity.

47. The apparatus of claim 38, wherein the transaction information includes a reader device identifier.

48. The apparatus of claim 47, wherein the means for analysing the stored transaction information comprises:
means, responsive to said reader device only appearing for transactions within at least one specific time-frame, for discounting each entry relating to said reader device as insignificant, whether a transaction appears within said at least one specific time-frame being determined using a timestamp associated with said transaction.

49. The apparatus of claim 48, wherein the means for analysing the stored transaction information comprises:
means, responsive to said reader device only appearing for transactions within at least one specific time-frame and said transactions having a low read count and said data being entered via a keypad associated with said reader device, for discounting each entry relating to said reader device as insignificant, whether a transaction appears within said at least one specific time-frame being determined using a timestamp associated with said transaction.

50. The apparatus of claim 28, comprising:
means, responsive to identifying any failing reader devices, for taking a second appropriate action.

51. The apparatus of claim 50, wherein said means for taking a second appropriate action comprises means for sending out a replacement reader device.

52. The apparatus of claim 28, wherein said data-holding entity is one of a security ID pass badge; a loyalty card; a store card; a membership card; a smart card; a key transponder; a bank card.

53. The apparatus of claim 28, wherein said reader device is in an automatic teller machine and said data-holding entity is a bank card.

54. The apparatus of claim 28, wherein said reader device is at least one of a fingerprint identification reader; and an iris identification reader.

55. A credit card system comprising:
a card-issuing bank;
a merchant bank; and
the apparatus of claim 28.

56. The credit card system of claim 55, wherein said merchant bank comprises:
storage associated therewith;
means for storing information relating to each transaction effected by a reader device served by said merchant bank; and wherein the means for analysing the transaction information associated with each identified reader device is at said merchant bank.

57. A computer program comprising program code means adapted to perform the method of claim 1 when said program is run on a computer.

58. A computer program comprising program code means adapted to perform the method of claim 9 when said program is run on a computer.
